(19) United States
(12) Patent Application Publication
(10) Pub. No.: US 2005/0194558 A1
(43) Pub. Date: Sep. 8, 2005

(54) Valve

(76) Inventors: Martin Carnall, Barwell (GB); Paul Garry, Middleton (GB)

Correspondence Address: Clifford Kraft, 320 Robin Hill Dr., Naperville, IL, 60540, US

(21) Appl. No.: 11/072,547

(22) Filed: Mar. 4, 2005

(30) Foreign Application Priority Data
Mar. 5, 2004 (GB) 0404988.8

(51) Int. Cl. F16K 31/00

(52) U.S. Cl. 251/344

(57) ABSTRACT

A valve for communicating a source 14 of compressed fluid with an opening 13 of an adjacent chamber 12 in a sleeve 11 comprises a circumferentially separated array of depressions 15 in the outer periphery of a bolt 10. Areas 19 and 20 of the bolt periphery between the depressions 15 serve to support the radially inner side of an O-ring seal 16 when the latter is aligned with the depressions.

This application is related to and claims priority from British Patent Application No. 0404988.8 filed Mar. 5, 2004.

This invention relates to a valve and more particularly to a valve between two elongated, telescopic components which can communicate axially spaced openings of the outer component when aligned with an axially elongated depression in the outer periphery of the inner component.

### BACKGROUND OF THE INVENTION

A valve of this kind is used in the paintball gun of our co-pending United States patent applications one of which is Ser. No. 10/775,756 and was filed on Feb. 9, 2004 and the other of which is Ser. No. 10/870,687 and was filed on Jun. 17, 2004. In those Applications the valve is used to communicate a source of compressed air with a chamber in which it is stored prior to being released through the bolt of the gun. When the gun is fired the valve serves to isolate the chamber from the source so that only the air stored in the chamber is used to fire a paintball.

In any pneumatic or hydraulic system using telescopic components it is necessary to provide O-ring seals in respective circumferential grooves on opposite sides of an opening in one of the components communicating with the source of compressed fluid if that opening is to be successfully occluded by the other component in the closed position of the valve. In the absence of such seals the compressed fluid may escape between the components.

According to the proposals of our said co-pending patent applications one of the O-ring seals on opposite sides of a bore communicating with a canister of compressed air must pass to or beyond the circumferential depression in the outer periphery of the bolt in order to communicate the bore with the interior of the storage chamber. The system works quite well but there is a danger that the said one O-ring may become deformed when it is aligned with the depression and therefore unsupported by the periphery of the bolt. The pressurised air entering the groove of the said O-ring may tend to displace it. Thus when the bolt moves back from its firing position the deformed or displaced O-ring may jam in the depression causing the mechanism to “lock up”.

A principal object of the present invention is to offer a solution to this problem.

### SUMMARY OF THE INVENTION

In accordance with one aspect of the present invention there is provided a valve operating between telescopic components to control communication between a source of pressurised fluid and an outlet by means of an O-ring seal axially displaceable with one of said components relative to an axially elongated opening in the other component, characterised in that said opening does not extend throughout the circumference of said other component such that when said O-ring is aligned with said opening to open communication between said source and said outlet it is supported by the peripheral surface of said other component on opposite circumferential sides of said opening.

Said opening is preferably one of a plurality of similar openings circumferentially spaced around said other component. The inner component may be tubular and said openings may be slots in the inner component which communicate its outer periphery with its interior.

Alternatively the openings may be depressions in the outer periphery of the inner component.

According to another aspect of the present invention there is provided a valve operating between telescopic components to bring axially spaced openings in the outer component into or out of alignment with an axially elongated depression in the outer periphery of the inner component, a pair of O-ring seals being positioned between the components in respective circumferential grooves on opposite sides of one of said openings, characterised in that the depression does not extend throughout the circumference of the inner component such that when one of said seals moves relatively into alignment with said depression to communicate said openings said one seal is supported by the outer periphery of the inner component on opposite circumferential sides of the depression.

Preferably the depression is one of a plurality of depressions spaced circumferentially about the outer periphery of the inner component.

In a preferred embodiment of the invention the components are respectively a sleeve and a bolt telescopically slideable within the sleeve, the sleeve and bolt being part of the mechanism of a paintball gun and the valve serving to communicate a chamber in the sleeve with a source of compressed air in a retracted position of the bolt and to isolate the chamber from the source in a firing position of the bolt.

### BRIEF DESCRIPTION OF THE DRAWINGS

A preferred embodiment of the invention will now be described by way of non-limitative example with reference to the accompanying drawings, in which:

FIG. 1 is a partial sectional elevation of a bolt of a paintball gun and a surrounding sleeve showing a valve in accordance with the invention in an open position, and

FIG. 2 is a view similar to FIG. 1 but showing the valve in the closed position.

### DETAILED DESCRIPTION OF A PREFERRED EMBODIMENT

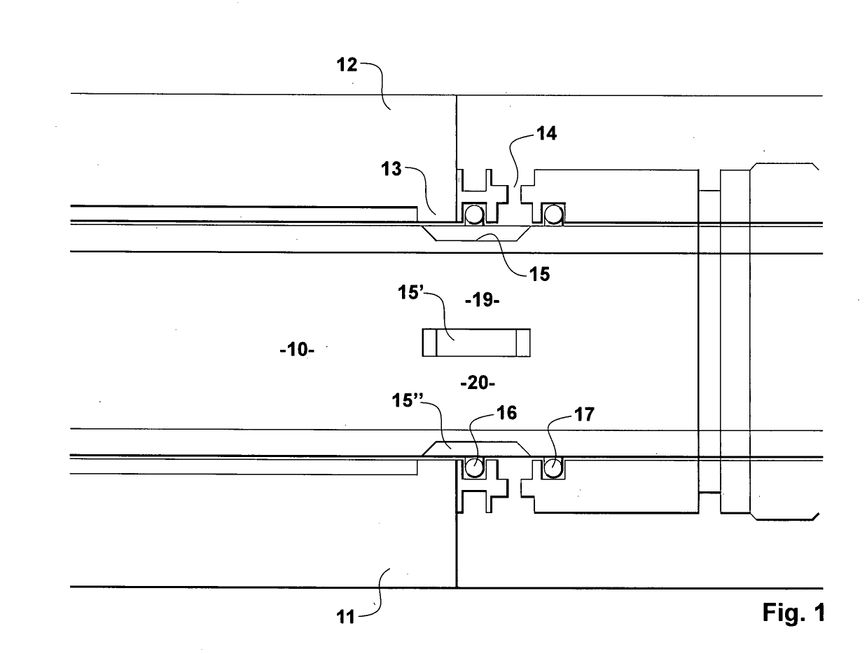

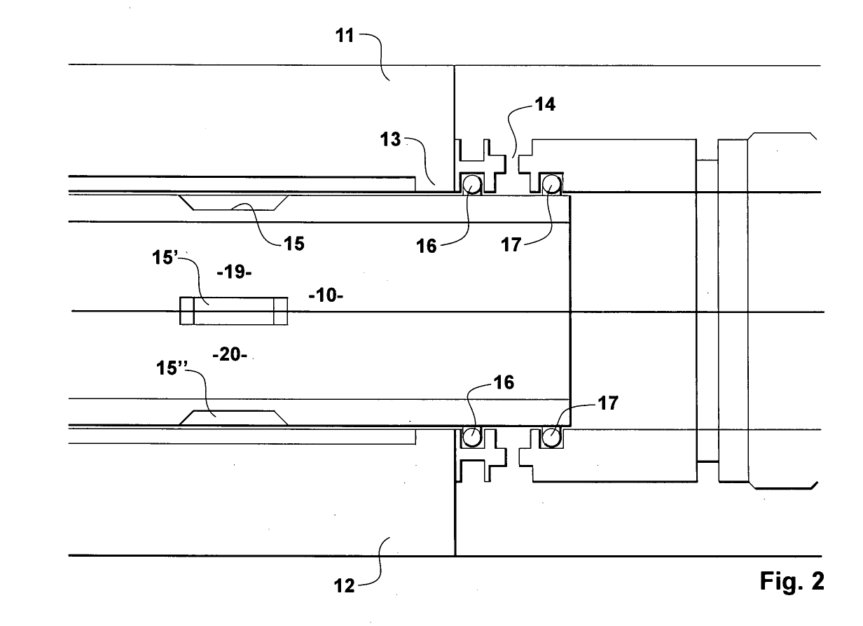

As described in our said co-pending patent applications, to which reference is made for a clearer understanding of the present invention, the bolt 10 of a paintball gun slides telescopically within a sleeve between a retracted position in which it is shown in FIG. 1 and a firing position in which it is shown in FIG. 2, in the latter position the interior of the bolt communicating with the interior of a chamber 12 in the sleeve so that compressed air stored in the chamber 12 will exit through the bolt to fire a paintball. In the retracted position of the bolt of FIG. 1 openings (not shown) of the chamber 12 to the interior of the bolt 10 and of the bolt 10 to the chamber 12 are misaligned so that the chamber is isolated from the bolt interior. On the other hand the chamber 12 communicates by an axially elongated opening 13 with a bore 14 connected to a source of compressed air (not shown) via a depression 15 in the outer periphery of the bolt 10. In the firing position of the bolt 10 (FIG. 2) however the depression moves out of alignment with the opening 13 and bore 14 and the periphery of the bolt 10 occludes both of them.

A pair of O-ring seals 16 and 17 are positioned in respective circumferential grooves in the sleeve 12 on opposite sides of the bore 14. Thus when the bolt 10 moves to the retracted position of FIG. 1 one of them, the seal 16, comes into alignment with the depression 15. If the depression 15 extended around the full circumference of the bolt 10 the seal 16 would be unsupported on its radially inner side. In accordance with the present invention, however, the depression 15 has only a small circumferential extent and is one of an array of such depressions such as 15′ and 15″. As the depressions 15 are machined out of the outer periphery of the bolt 10 portions such as 19 and 20 of the outer periphery of the bolt on opposite circumferential sides of the depressions support the seal 16 on its radially inner side while it is aligned with the depressions.

1. A valve operating between telescopic components to control communication between a source of pressurised fluid and an outlet by means of an O-ring seal axially displaceable with one of said components relative to an axially elongated opening in the other component, characterised in that said opening does not extend throughout the circumference of said other component such that when said O-ring is aligned with said opening to open communication between said source and said outlet it is supported by the peripheral surface of said other component on opposite circumferential sides of said opening.

2. A valve as claimed in claim 1, wherein said opening is one of a plurality of similar openings circumferentially spaced around said other component.

3. A valve as claimed in claim 2, wherein the inner component is tubular and said openings are slots in the inner component which communicate its outer periphery with its interior.

4. A valve as claimed in claim 2, wherein the openings are depressions in the outer periphery of the inner component.

5. A valve operating between telescopic components to bring axially spaced openings in the outer component into or out of alignment with an axially elongated depression in the outer periphery of the inner component, a pair of O-ring seals being positioned between the components in respective circumferential grooves on opposite sides of one of said openings, characterised in that the depression does not extend throughout the circumference of the inner component such that when one of said seals moves relatively into alignment with said depression to communicate said openings said one seal is supported by the outer periphery of the inner component on opposite circumferential sides of the depression.

6. A valve as claimed in claim 5, wherein the depression is one of a plurality of depressions circumferentially spaced about the outer periphery of the inner component.

7. A valve as claimed in claim 6, wherein the components are respectively a sleeve and a bolt telescopically slideable within the sleeve, the sleeve and bolt being part of the mechanism of a paintball gun and the valve serving to communicate a chamber in the sleeve with a source of compressed air in a retracted position of the bolt and to isolate the chamber from the source in a firing position of the bolt.
